(19) United States
(12) Patent Application Publication
(10) Pub. No.: US 2022/0101137 A1
(43) Pub. Date: Mar. 31, 2022

(54) LEARNING DEVICE, EXTRACTION DEVICE, LEARNING METHOD, EXTRACTION METHOD, LEARNING PROGRAM, AND EXTRACTION PROGRAM

(71) Applicant: NTT Communications Corporation, Tokyo (JP)

(72) Inventors: Keisuke KIRITOSHI, Kawasaki-shi (JP); Tomonori IZUMITANI, Tokyo (JP); Ryosuke TANNO, Tokyo (JP)

(73) Assignee: NTT Communications Corporation, Tokyo (JP)

(21) Appl. No.: 17/547,249

(22) Filed: Dec. 10, 2021

Related U.S. Application Data
(63) Continuation of application No. PCT/JP2020/023285, filed on Jun. 12, 2020.

(30) Foreign Application Priority Data
Jun. 13, 2019 (JP) 2019-110681

(51) Int. Cl. G06N 3/08; G06K 9/62; G05B 19/418

(52) U.S. Cl. CPC G06N 3/08; G05B 19/4183; G06K 9/6232

(57) ABSTRACT

A learning device includes processing circuitry configured to collect a plurality of data, calculate, when inputting the plurality of data as input data to a model and obtaining output data that is output from the model, an attribution that is a degree of contribution of each element of the input data to the output data, based on the input data and the output data, and apply a restriction on the attribution thereto and learn the model.

### CROSS-REFERENCE TO RELATED APPLICATIONS

This application is a continuation application of International Application No. PCT/JP2020/023285, filed on Jun. 12, 2020 which claims the benefit of priority of the prior Japanese Patent Application No. 2019-110681, filed on Jun. 13, 2019, the entire contents of which are incorporated herein by reference.

### FIELD

The present invention relates to a learning device, an extraction device, a learning method, an extraction method, a learning program, and an extraction program.

### BACKGROUND

For application of a neural network technique to industry or manufacturing, the neural network is a black box where a basis for determination thereof or a relationship between an input and an output is unclear, so that it is difficult to utilize it as an application. Hence, it has been known that reliability of a model is improved by extracting a relationship between an input and an output (an attribution) so that it is possible to execute an investigation into a cause of prediction. For example, it may be possible for an operator of a plant to understand a cause of prediction and obtain an action for preventing a failure by comparing an attribution with a failure that is predicted by a neural network model.

A plurality of methods that extract a relationship between an input and an output (an attribution) of a neural network model have been proposed. Such methods are different from a method that extracts a degree of importance of an input from a weight of a model as used in a linear model or the like, and obtain a relationship between an input and an output for each sample so as to have an advantage that it is possible to extract a relationship that is dependent on a state of data.

For example, a method that utilizes a value of partial differentiation of an input with respect to an output is provided as a method that extracts an attribution. Furthermore, as an evolutionary system that reduces noise, a method that utilizes a value of partial differentiation or calculates an attribution by yet another definition has been proposed.

Non Patent Document 1: Smilkov Daniel, et al. “Smoothgrad: removing noise by adding noise.” arXiv preprint 1706.03825 (2017).

Non Patent Document 2: Simonyan, Karen, Andrea Vedaldi, and Andrew Zisserman. “Deep inside convolutional networks: Visualising image classification models and saliency maps.” arXiv preprint arXiv: 1312.6034 (2013).

Non Patent Document 3: Binder, Alexander, et al. “Layer-wise relevance propagation for deep neural network architectures.” Information Science and Applications (ICISA) 2016. Springer, Singapore, 2016. 913-922.

However, in a method that extracts a relationship between an input and an output (an attribution) of a related neural network model, a lot of great noise may be included in an extracted attribution. For example, in a method that utilizes a value of partial differentiation of an input with respect to an output, a lot of noise may be provided. Furthermore, a problem is provided in that, even if a calculation method for an attribution that eliminate noise is used, interpretation of such an attribution per se may be difficult.

### SUMMARY

It is an object of the present invention to at least partially solve the problems in the related technology.

According to an aspect of the embodiments, a learning device includes: processing circuitry configured to: collect a plurality of data; calculate, when inputting the plurality of data as input data to a model and obtaining output data that is output from the model, an attribution that is a degree of contribution of each element of the input data to the output data, based on the input data and the output data; and apply a restriction on the attribution thereto and learn the model.

According to another aspect of the embodiments, an extraction device includes: processing circuitry configured to: collect a plurality of data; calculate, when inputting the plurality of data as input data to a model and obtaining output data that is output from the model, an attribution that is a degree of contribution of each element of the input data to the output data, based on the input data and the output data; apply a restriction on the attribution thereto and learn the model; and extract, when inputting input data to a learned model that has been learned and obtaining output data that is output from the learned model, an attribution of each element of the input data to the output data, based on the input data and the output data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a block diagram that illustrates a configuration example of a learning device according to a first embodiment;

FIG. 2 is a diagram that explains an outline of a learning process that is executed by a learning device;

FIG. 3 is a diagram that explains a specific process example of a learning process that is executed by a learning device;

FIG. 4 is a flowchart that illustrates an example of a flow of a learning process in a learning device according to a first embodiment;

FIG. 5 is a block diagram that illustrates a configuration example of an extraction device according to a second embodiment;

FIG. 6 is a diagram that explains an outline of an anomaly prediction process and an attribution extraction process that are executed by an extraction device;

FIG. 7 is a diagram that explains an outline of an image classification process and an attribution extraction process that are executed by an extraction device;

FIG. 8 is a flowchart that illustrates an example of a flow of an extraction process in an extraction device according to a second embodiment; and

FIG. 9 is a diagram that illustrates a computer that executes a program.

### DESCRIPTION OF EMBODIMENT(S)

Preferred embodiments will be explained with reference to accompanying drawings. Hereinafter, an embodiment(s) of a learning device, an extraction device, a learning method, an extraction method, a learning program, and an extraction program according to the present application will be explained in detail based on the drawing(s). Additionally, a learning device, an extraction device, a learning method, an extraction method, a learning program, and an extraction program according to the present application are not limited by such an embodiment(s).

### First Embodiment

In a below-mentioned embodiment, a configuration of a learning device 10 according to a first embodiment and a flow of a process of the learning device 10 will be explained sequentially, and an effect that is provided by such a first embodiment will be explained finally.

Configuration of Learning Device

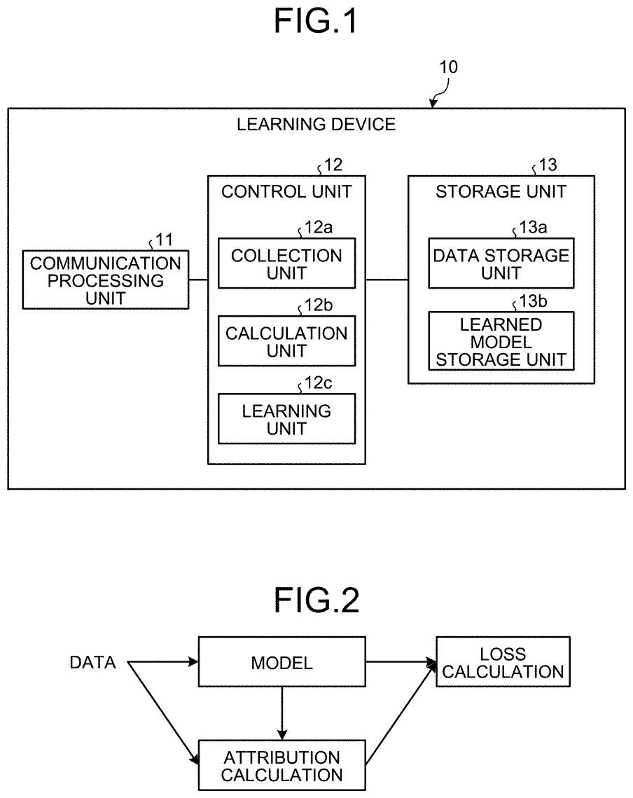

First, a configuration of the learning device 10 will be explained by using FIG. 1. FIG. 1 is a block diagram that illustrates a configuration example of a learning device according to a first embodiment. For example, the learning device 10 collects a plurality of data that are acquired by a senor that is placed in a monitoring target facility such as a factory or a plant and learns a prediction model for predicting anomaly of the monitoring target facility while the plurality of collected data are provided as an input thereto. In the learning device 10, learning is executed by using a simple and existing calculation method for an attribution such as a value of partial differentiation of an input with respect to an output and applying thereto a restriction (for example, a restriction of sparsity increase) where an attribution is changed during learning, so that it is possible to reduce noise of the attribution. Furthermore, in the learning device 10, a calculation method for an attribution does not have to be changed so as to intend reduction of noise, so that it is also possible to reduce difficulty of interpretation of an attribution per se.

As illustrated in FIG. 1, such a learning device 10 has a communication processing unit 11, a control unit 12, and a storage unit 13. A process of each unit that is possessed by the learning device 10 will be explained below.

The communication processing unit 11 controls communication of various types of information that is communicated with a device that is connected thereto. Furthermore, the storage unit 13 stores data and a program that are needed for various types of processes that are executed by the control unit 12 and has a data storage unit 13a and a learned model storage unit 13b. For example, the storage unit 13 is a storage device such as a semiconductor memory element such as a RAM (Random Access Memory) or a flash memory (Flash Memory).

The data storage unit 13a stores data that are collected by a collection unit 12a as described later. For example, the data storage unit 13a stores data (for example, data such as a temperature, a pressure, a sound, or an oscillation) of a sensor that is provided on a target instrument such as a factory, a plant, a building, or a data sensor. Additionally, data as described above are not limiting and the data storage unit 13a may store any data as long as data that include a plurality of real number values, such as image data, are provided.

The learned model storage unit 13b stores a learned model that has been learned by a learning unit 12c as described later. For example, the learned model storage unit 13b stores a prediction model of a neural network for predicting anomaly of a monitoring target facility as a leaned model.

The control unit 12 has an internal memory for storing a program that defines various types of process procedures or the like and needed data and thereby executes a variety of processes. For example, the control unit 12 has a collection unit 12a, a calculation unit 12b, and a learning unit 12c. Herein, the control unit 12 is, for example, an electronic circuit such as a CPU (Central Processing Unit), an MPU (Micro Processing Unit), or a GPU (Graphical Processing Unit), or an integrated circuit such as an ASIC (Application Specific Integrated Circuit) or an FPGA (Field Programmable Gate Array).

The collection unit 12a collects a plurality of data. For example, the collection unit 12a collects a plurality of sensor data that are acquired in a monitoring target facility. Specifically, the collection unit 12a periodically (for example, every minute) receives multivariate and time-series numerical data from a sensor that is placed on a monitoring target facility such as a factory or a plant and stores them in the data storage unit 13a. Herein, data that are acquired by a sensor are, for example, various types of data such as a temperature, a pressure, a sound, or an oscillation of a device or a reactor in a factory or a plant that is a monitoring target facility. Furthermore, data that are acquired by the collection unit 12a are not limited to data that are acquired by a sensor and may be, for example, image data, numerical data that are input personally, or the like.

The calculation unit 12b calculates, when inputting a plurality of data as input data to a model and obtaining output data that are output from the model, an attribution that that is a degree of contribution of each element of the input data to the output data, based on the input data and the output data. For example, the calculation unit 12b calculates, when inputting a plurality of sensor data as input data to a prediction model for predicting a state of a monitoring target facility and obtaining output data that are output from the prediction model, an attribution for each sensor, based on the input data and the output data.

Herein, a specific example of calculating of an attribution will be explained. For example, the calculation unit 12b calculates an attribution for each sensor at each point of time by using a value of partial differentiation of an output value with respect to each input value or a roughly estimated value thereof in a learned model that calculates an output value from an input value. As an example thereof, the calculation unit 12b calculates an attribution for each sensor at each point of time, by using Saliency Map. Saliency Map is a technique that is utilized in image classification of a neural network and is a technique that extracts a value of partial differentiation of an output of a neural network with respect to each input thereto as an attribution that contributes to the output. Additionally, an attribution may be calculated by a method other than Saliency Map.

The learning unit 12c applies a restriction on an attribution thereto and learns a model. For example, the learning unit 12c applies a restriction on an attribution to a loss function that calculates a loss of a model based on output data and correct answer data and learns a model.

Herein, an outline of a learning process that is executed by the learning device 10 will be explained by using FIG. 2. FIG. 2 is a diagram that explains an outline of a learning process that is executed by a learning device. As illustrated in FIG. 2, the calculation unit 12b calculates, when inputting a plurality of data as input data to a model and obtaining output data that are output from the model, an attribution, based on the input data that are input to the model and the output data that are output from the model.

Furthermore, the learning unit 12c calculates a loss from output data of a model and correct answer data and provides an attribution to the calculated loss, so that it is possible to apply thereto a restriction where an attribution that is calculated from a learned model that is finally obtained is changed. For example, if a restriction of sparsity increase (that sets an attribution of an unimportant feature at 0) is applied thereto, the learning unit 12c adds a value that is provided by multiplying an L1 norm of an attribution by a preliminarily set constant α to a loss and learns a model in such a manner that the loss where the L1 norm is added is decreased. Thus, the learning unit 12c adds a value that is provided by multiplying an L1 norm of an attribution by a preliminarily set constant, as a restriction on the attribution, to a loss function and learns a model in such a manner that the loss where the L1 norm is added is decreased and a sparsity of the attribution is increased.

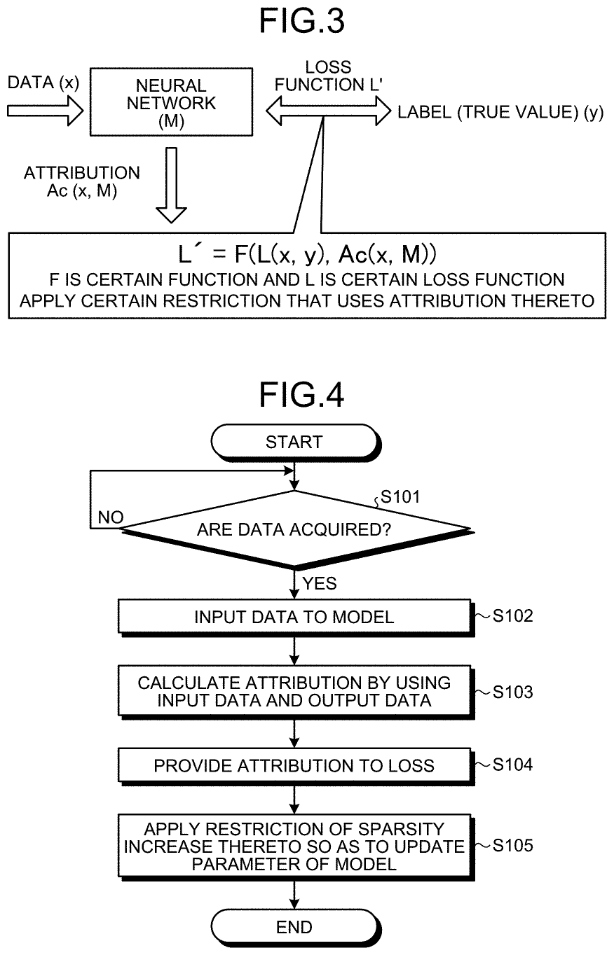

Herein, a specific process example of a learning process that is executed by the learning device 10 will be explained by using FIG. 3. FIG. 3 is a diagram that explains a specific process example of a learning process that is executed by a learning device. In an example of FIG. 3, the calculation unit 12b calculates, when input data x are input to a neural network M, an attribution A_{c} (x, M). As illustrated in FIG. 3, the learning unit 12c applies a certain restriction that uses an attribution thereto and executes learning of a neural network M. For example, if the learning unit 12c applies a restriction of sparsity increase thereto, a loss function is provided as

“L′=L(x,y)+α|A_{c}(x,y,M)|”.

Furthermore, when Saliency Map is used as a method that calculates an attribution, a loss function that adds an L1 norm of Saliency Map (a value of partial differentiation) to a loss L(x, y) is provided as formula (1) as described above. Herein, the learning unit 12c calculates an L1 norm of ∂S_{c}(x)/∂x. Herein, c represents an output node of a model. For example, in a case of a regression model, it is possible to use an output (generally, a real number value) of a model M as S_{c}(x). Furthermore, in a case of a classification model, it is possible to use an input value (generally, a real number value) of a Softmax function that is provided as a final layer of a model M.

$${L}^{′} = L ( x , y ) + α \vert \frac{\partial {S}_{c} ( x )}{\partial x} \vert \qquad ( 1 )$$

For such an L1 norm of Saliency Map (a value of partial differentiation), when a plurality of sample data are input thereto, the learning unit 12c obtains, for example, an average value of respective sample data. For example, if n sample data (for example, n image data) are provided, i is a sample number (a number that identifies image data), and j is a feature number (a number that identifies a pixel position of image data), a L1 norm of Saliency Map (a value of partial differentiation) of each sample is represented by formula (2) as described below.

$$\frac{1}{n} {\sum }_{i}^{n} {\sum }_{j} \vert \frac{\partial {S}_{c} ( {x}_{i} )}{\partial {x}_{ij}} \vert = \vert \frac{\partial {S}_{c} ( x )}{\partial x} \vert \qquad ( 2 )$$

Thus, the learning device 10 applies thereto a restriction where an attribution is changed during learning (for example, sparsity increase or a restriction that sets an unwanted attribution at 0) without changing a calculation method for an attribution so as to intend reduction of noise, and executes learning. Hence, in the learning device 10, an existing method is used for a calculation method for an attribution and a learning method is improved, so that it is possible to prevent or reduce noise of an attribution.

For example, in the learning device 10, even when a simple attribution such as a value of partial differentiation of an input with respect to an output is utilized, it is possible to reduce noise of the attribution and simultaneously it is possible to reduce difficulty of interpretation of the attribution per se as compared with a related method. Furthermore, it is also possible to maintain a feature of an attribution that is changed for each sample.

Process Procedure of Learning Device

Next, an example of a process procedure that is executed by the learning device 10 according to a first embodiment will be explained by using FIG. 4. FIG. 4 is a flowchart that illustrates an example of a flow of a learning process in a learning device according to a first embodiment.

As illustrated in FIG. 4, the learning device 10, inputs, when acquiring data (step S101, Yes), data to a model (step S102) and calculates an attribution by using input data and output data (step S103). For example, the calculation unit 12b of the learning device 10 calculates, when inputting a plurality of sensor data as input data to a prediction model for predicting a state of a monitoring target facility and obtaining output data that are output from the prediction model, an attribution for each sensor, based on the input data and the output data.

Then, the learning device 10 provides an attribution to a loss (step S104) and applies a restriction of sparsity increase thereto so as to update a parameter of a model (step S105). For example, the learning unit 12c executes a learning process that calculates a loss of a model based on output data and correct answer data, provides an attribution to the loss, and updates a parameter of a prediction model in such a manner that the loss where the attribution is provided is decreased and a sparsity of the attribution is increased. Herein, for example, the learning device 10 executes processes at steps S102 to S105 as described above every time new data are acquired, so as to execute a learning process of a model repeatedly. Furthermore, for example, the learning device 10 may repeat a process that updates a parameter of a model as described above until a predetermined end condition is satisfied and end a learning process of the model when the predetermined end condition is satisfied. Subsequently, the learning device 10 outputs a learned model or stores the learned model in the learned model storage unit 13b.

### Effect of First Embodiment

The learning device 10 according to a first embodiment calculates, when collecting a plurality of data, inputting the plurality of data as input data to a model, and obtaining output data that are output from the model, an attribution that is a degree of contribution of each element of the input data to the output data, based on the input data and the output data. Then, the learning device 10 applies a restriction on an attribution thereto and learns a model. Hence, in the learning device 10, it is possible to prevent or reduce noise of an attribution without changing a calculation method for an attribution so as to intend reduction of noise. That is, in the learning device 10, a restriction is provided to an attribution at a time of learning, so that, for example, it is possible to maintain an interpretation property of an attribution and reduce noise.

### Second Embodiment

Although a learning device that learns a model has been explained in the first embodiment as described above, an extraction device that extracts an attribution by using a learned model that has been obtained by a learning process will be explained in a second embodiment. In a below-mentioned second embodiment, a configuration of an extraction device 10A according to the second embodiment and a flow of a process of the extraction device 10A will be explained sequentially and an effect that is provided by a second embodiment will be explained finally.

Additionally, an explanation(s) of a configuration and a process that are similar to those of the first embodiment will be omitted.

Configuration of Extraction Device

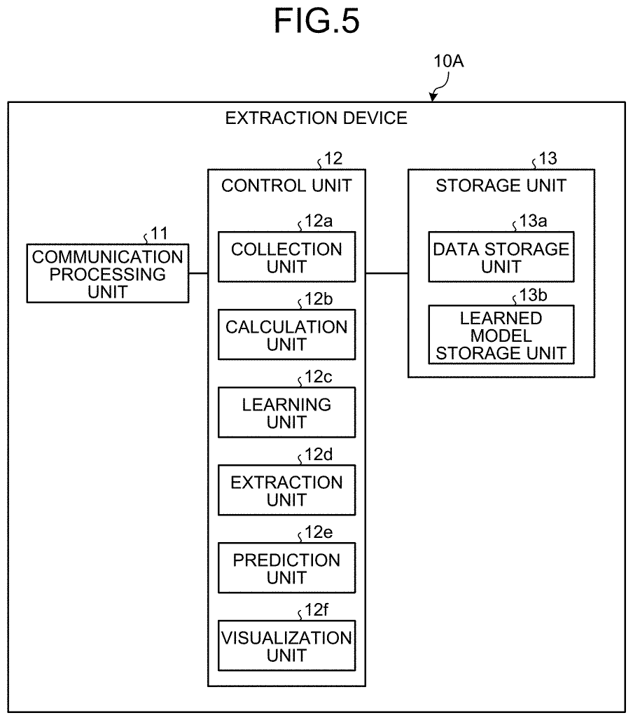

First, a configuration of the extraction device 10A will be explained by using FIG. 5. FIG. 5 is a block diagram that illustrates a configuration example of an extraction device according to a second embodiment. For example, the extraction device 10A collects a plurality of data that are acquired by a sensor that is placed in a monitoring target facility such as a factory or a plant and outputs an estimated value of a particular sensor of the monitoring target facility by using a learned model for predicting anomaly of the monitoring target facility while the plurality of collected data are provided as an input. Furthermore, the extraction device 10A may calculate a degree of anomaly from thus output estimated value. For example, when a regression model is learned where a value of a particular sensor is provided as an objective variable, it is possible to define a degree of anomaly as an error or the like between an estimated value of such a sensor that is output by a model and a particular value that is specified preliminarily or the like. Alternatively, when a model is learned while dealing with presence or absence of causing of anomaly as a classification problem, it is possible to utilize a rate or the like of a time zone that is classified as anomaly in a specified period of time. Furthermore, the extraction device 10A calculates an attribution that is a degree of contribution to an output value of each sensor by using data of each sensor that are input to a learned model and output data that are output from the learned model. Herein, an attribution indicates how much contribution of each input to an output is provided, and means that a degree of influence of such an input on an output is increased with increasing an absolute value of the attribution.

The extraction device 10A has a communication processing unit 11, a control unit 12, and a storage unit 13. The control unit 12 has a collection unit 12a, a calculation unit 12b, a learning unit 12c, an extraction unit 12d, a prediction unit 12e, and a visualization unit 12f. Herein, the extraction device 10A is different from the learning device 10 in that it further has the extraction unit 12d, the prediction unit 12e, and the visualization unit 12f. Additionally, the collection unit 12a, the calculation unit 12b, and the learning unit 12c execute processes that are similar to those of the collection unit 12a, the calculation unit 12b, and the learning unit 12c of the learning device 10 that have been explained in the first embodiment, and an explanation(s) thereof will be omitted.

The extraction unit 12d extracts, when inputting input data to a learned model that has been learned by the learning unit 12c and obtaining output data that are output from the learned model, an attribution of each element of the input data to the output data, based on the input data and the output data. For example, the extraction unit 12d inputs, when reading a learned model from the learned model storage unit 13b and acquiring data from the data storage unit 13a, the data to the learned model and extracts an attribution for each of the data.

For example, the extraction unit 12d calculates an attribution for each sensor at each point of time by using a value of partial differentiation of an output value with respect to each input value or a roughly estimated value thereof in a learned model that calculates an output value from an input value. As an example thereof, the extraction unit 12d calculates an attribution for each sensor at each point of time by using Saliency Map.

The prediction unit 12e outputs a predetermined output value by using a learned model for predicting a state of a monitoring target facility while a plurality of data that are collected by the collection unit 12a are provided as an input. For example, the prediction unit 12e calculates a degree of anomaly of a monitoring target facility by using process data and a learned model (a discriminant function and a regression function) and predicts whether or not anomaly is caused after a certain period of time that is preliminarily set.

The visualization unit 12f visualizes an attribution that is extracted by the extraction unit 12d or a degree of anomaly that is calculated by the prediction unit 12e. For example, the visualization unit 12f displays a graph that indicates transition of an attribution of data of each sensor or displays a calculated degree of anomaly as a chart screen.

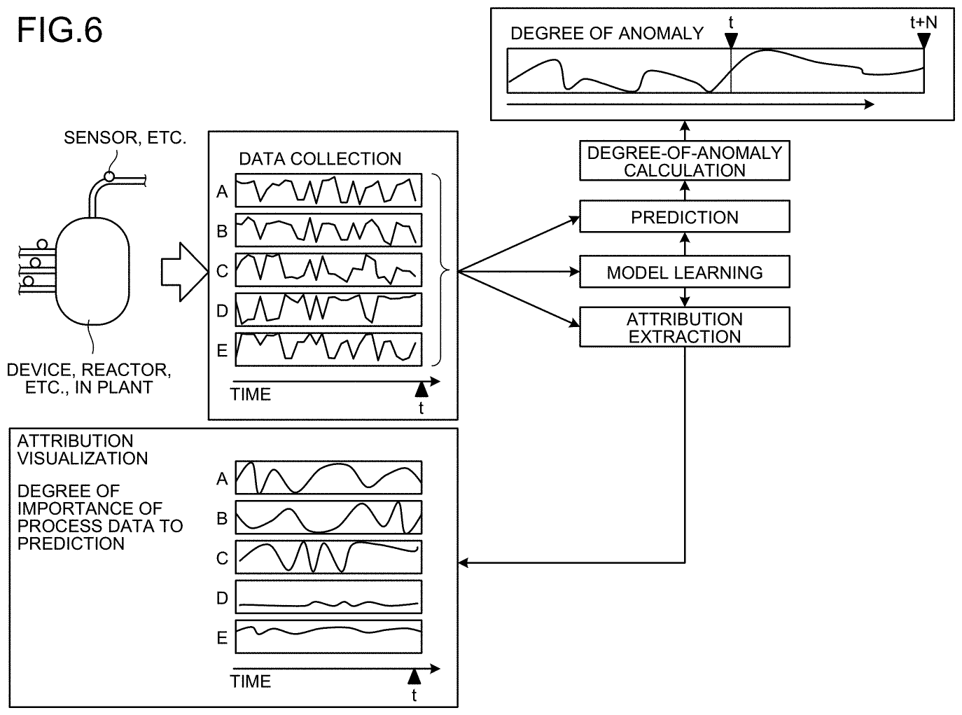

Herein, an outline of an anomaly prediction process and an attribution extraction process that are executed by the extraction device 10A will be explained by using FIG. 6. FIG. 6 is a diagram that explains an outline of an anomaly prediction process and an attribution extraction process that are executed by an extraction device.

FIG. 6 illustrates a sensor or a device that collects a signal for an operation or the like that is attached to a reactor, a device, or the like in a plant and collects data every certain period of time. Then, FIG. 6 illustrates transition of process data that are collected from each of sensor A to sensor E by the collection unit 12a where the learning unit 12c learns a model so as to produce a learned model as explained in the first embodiment. Then, the prediction unit 12e predicts anomaly after a certain period of time by using a learned model. Then, the visualization unit 12f outputs time-series data of a calculated degree of anomaly as a chart screen.

Furthermore, the extraction unit 12d extracts an attribution to a predetermined output value for each sensor at each point of time by using process data that are input to a learned model and an output value from the learned model. Then, the visualization unit 12f displays a graph that indicates transition of a degree of importance of process data of each sensor to prediction.

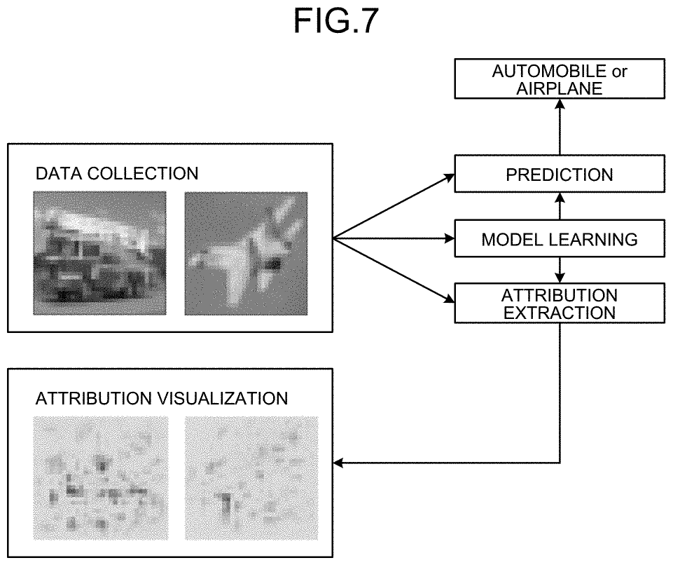

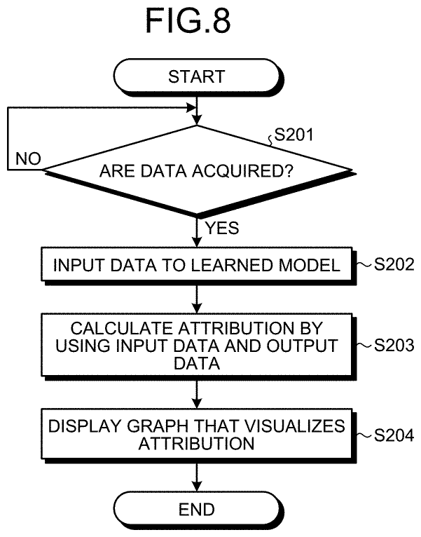

Furthermore, the extraction device 10A is not only applied to an anomaly prediction process and may, for example, collect image data and be applied to an image classification process. Herein, an outline of an image classification process and an attribution extraction process that are executed by the extraction device 10A will be explained by using FIG. 7. FIG. 7 is a diagram that explains an outline of an image classification process and an attribution extraction process that are executed by an extraction device.

In FIG. 7, the collection unit 12a collects image data and the learning unit 12c learns a model by using the collected image data as input data so as to produce a learned model as explained in the first embodiment. Then, the prediction unit 12e classifies an image that is included in image data by using a learned model. For example, in an example of FIG. 7, the prediction unit 12e determines whether an image that is included in image data is an image of an automobile or an image of an airplane and output a result of determination thereof.

Furthermore, the extraction unit 12d extracts an attribution for each pixel in each image by using image fata that are input to a learned model and a result of classification that is output from the learned model. Then, the visualization unit 12f displays an image that indicates an attribution for each pixel in each image. In such an image, an attribution is expressed by a density where display is executed in such a manner that a density of a predetermined color is increased with increasing an attribution of a pixel and a density of the predetermined color is decreased with decreasing an attribution of a pixel.

Thus, the extraction device 10A extracts, when inputting input data to a learned model that has been learned by the learning unit 12c and obtaining output data that are output from the learned model, an attribution of each element of the input data to the output data, based on the input data and the output data. In the extraction device 10A, a learned model that has been learned by applying a restriction thereto in such a manner that an attribution is changed is applied, so that it is possible to reduce noise of the attribution even when a simple attribution such as a value of partial differentiation of an input with respect to an output is utilized. Furthermore, in the extraction device 10A, a calculation method for an attribution does not have to be changed so as to intend reduction of noise, so that it is possible to reduce difficulty of interpretation of an attribution per se. Furthermore, a feature of an attribution that is changed for each sample is also maintained. Hence, it is possible for an observer to observe an attribution with less noise that is readily interpreted as compared with a related one, so that it is possible to apply it to control or behavior more readily.

System Configuration, etc.

Furthermore, each component of each device as illustrated in the figure(s) is functionally conceptual and a physical configuration does not have to be provided as illustrated in the figure(s). That is, a specific mode of dispersion or integration of each device is not limited to one as illustrated in the figure(s) where it is possible to disperse or integrate all or a part thereof functionally or physically at any unit depending on various types of loads, usages, or the like so as to provide a configuration. Moreover, for each process function that is executed in each device, it is possible to realize all or any part thereof by a CPU, a GPU, and a program that is analyzed and executed in the CPU or GPU or realize it/them as hardware that is provided by a wired logic.

Furthermore, among respective processes that are explained in the present embodiment, it is also possible to manually execute all or a part of processes that are explained in such a manner that they are executed automatically or it is also possible to automatically execute all or a part of processes that are explained in such a manner that they are executed manually, according to a publicly known method. As for the rest, it is possible to arbitrarily change information that includes a process procedure, a control procedure, a specific name, or various types of data or parameters as illustrated in a document(s) or a drawing(s) as described above, unless otherwise described.

Program

Furthermore, it is also possible to create a program where a process that is executed by an information processing apparatus that is explained in an embodiment as described above is described in a computer-executable language. For example, it is also possible to create a program where a process that is executed by the learning device 10 or the extraction device 10A according to an embodiment is described in a computer-executable language. In such a case, a computer executes a program, so that it is possible to obtain an effect that is similar to that of an embodiment as described above. Moreover, a process that is similar to that of an embodiment as described above may be realized by recoding such a program in a computer-readable recoding medium and causing a computer to read and execute the program that is recorded in such a recording medium.

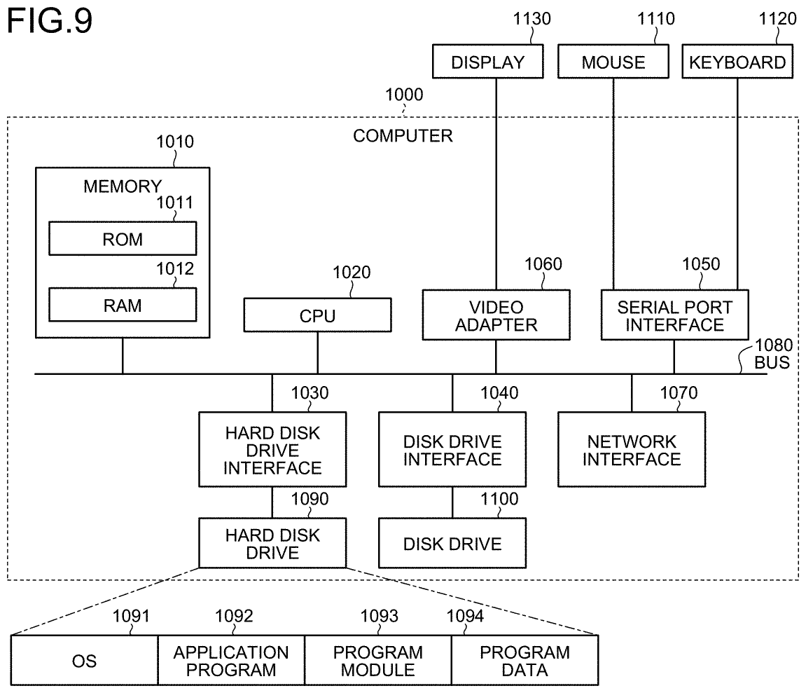

FIG. 9 is a diagram that illustrates a computer that executes a program. As illustrated in FIG. 9, a computer 1000 has, for example, a memory 1010, a CPU 1020, a hard disk drive interface 1030, a disk drive interface 1040, a serial port interface 1050, a video adapter 1060, and a network interface 1070 where such respective units are connected by a bus 1080.

As illustrated in FIG. 9, the memory 1010 includes a ROM (Read Only Memory) 1011 and a RAM 1012. The ROM 1011 stores, for example, a boot program such as BIOS (Basic Input Output System). As illustrated in FIG. 9, the hard disk drive interface 1030 is connected to a hard disk drive 1090. As illustrated in FIG. 9, the disk drive interface 1040 is connected to a disk drive 1100. For example, an attachable and detachable storage medium such as a magnetic disk or an optical disk is inserted into the disk drive 1100. As illustrated in FIG. 9, the serial port interface 1050 is connected to, for example, a mouse 1110 and a keyboard 1120. As illustrated in FIG. 9, the video adapter 1060 is connected to, for example, a display 1130.

Herein, as illustrated in FIG. 9, the hard disk drive 1090 stores, for example, an OS 1091, an application program 1092, a program module 1093, and program data 1094. That is, a program as described above is stored as a program module where a command that is executed by the computer 1000 is described, in, for example, the hard disk drive 1090.

Furthermore, various types of data that are explained in an embodiment as described above are stored as program data in, for example, the memory 1010 or the hard disk drive 1090. Then, the CPU 1020 reads, in the RAM 1012, the program module 1093 and the program data 1094 that are stored in the memory 1010 or the hard disk drive 1090, as needed, and executes various types of process procedures.

Additionally, a case where the program module 1093 and the program data 1094 in association with a program are stored in the hard disk drive 1090 is not limiting and they may be, for example, stored in an attachable and detachable storage medium and read by the CPU 1020 through a disk drive or the like. Alternatively, the program module 1093 and the program data 1094 in association with a program may be stored in another computer that is connected thereto through a network (such as a LAN (Local Area Network) or a WAN (Wide Area Network)) and read by the CPU 1020 through the network interface 1070.

According to the present invention, an effect is produced in such a manner that it is possible to prevent or reduce noise of an attribution without changing a calculation method for the attribution so as to intend reduction of the noise.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning device comprising:
processing circuitry configured to:
collect a plurality of data;
calculate, when inputting the plurality of data as input data to a model and obtaining output data that is output from the model, an attribution that is a degree of contribution of each element of the input data to the output data, based on the input data and the output data; and
apply a restriction on the attribution thereto and learn the model.

2. The learning device according to claim 1, wherein the processing circuitry is further configured to apply a restriction on the attribution to a loss function that calculates a loss of the model based on the output data and correct answer data, and learn the model.

3. The learning device according to claim 2, wherein the processing circuitry is further configured to add a value that is provided by multiplying an L1 norm of the attribution by a preliminarily set constant, as a restriction on the attribution, to the loss function, and learn the model in such a manner that a loss that is provided by adding the L1 norm thereto is decreased and a sparsity of the attribution is increased.

4. The learning device according to claim 1, wherein the processing circuitry is further configured to:
collect a plurality of sensor data that are acquired by a monitoring target facility,
calculate, when inputting the plurality of sensor data as input data to a prediction model for predicting a state of the monitoring target facility and obtaining output data that is output from the prediction model, the attribution for each sensor, based on the input data and the output data, and
apply a restriction on the attribution thereto and learn the prediction model.

5. An extraction device comprising:
processing circuitry configured to:
collect a plurality of data;
calculate, when inputting the plurality of data as input data to a model and obtaining output data that is output from the model, an attribution that is a degree of contribution of each element of the input data to the output data, based on the input data and the output data;
apply a restriction on the attribution thereto and learn the model; and
extract, when inputting input data to a learned model that has been learned and obtaining output data that is output from the learned model, an attribution of each element of the input data to the output data, based on the input data and the output data.

6. A learning method comprising:
collecting a plurality of data;
calculating, when inputting the plurality of data as input data to a model and obtaining output data that is output from the model, an attribution that is a degree of contribution of each element of the input data to the output data, based on the input data and the output data; and
applying a restriction on the attribution thereto and learning the model, by processing circuitry.

7. An extraction method comprising:
collecting a plurality of data;
calculating, when inputting the plurality of data as input data to a model and obtaining output data that is output from the model, an attribution that is a degree of contribution of each element of the input data to the output data, based on the input data and the output data;
applying a restriction on the attribution thereto and learning the model, by processing circuitry; and
extracting, when inputting input data to a learned model that has been learned and obtaining output data that is output from the learned model, an attribution of each element of the input data to the output data, based on the input data and the output data.

8. A non-transitory computer-readable recording medium storing therein a learning program that causes a computer to act as the learning device according to claim 1.

9. A non-transitory computer-readable recording medium storing therein an extraction program that causes a computer to act as the extraction device according to claim 5.
